(19) United States
(12) Patent Application Publication
(10) Pub. No.: US 2021/0265716 A1
(43) Pub. Date: Aug. 26, 2021

(54) Methods of Plating onto Sacrificial Material and Components Made Therefrom

(71) Applicant: AVERATEK CORPORATION, Santa Clara, CA (US)

(72) Inventors: Haris BASIT, San Jose, CA (US); Michael Riley VINSON, Sunnyvale, CA (US)

(21) Appl. No.: 17/180,456

(22) Filed: Feb. 19, 2021

Related U.S. Application Data
(60) Provisional application No. 62/979,190, filed on Feb. 20, 2020.

(51) Int. Cl. H01P 11/00; H01P 3/12; C25D 7/04; C25D 1/02

(52) U.S. Cl. CPC H01P 11/002; C25D 1/02; C25D 7/04; H01P 3/121

(57) ABSTRACT

Systems, methods, and devices related to hollow metallic objects are disclosed. A solid sacrificial material is formed in a desired three-dimensional shape, and a precursor is deposited about an exterior surface of the solid sacrificial material. The precursor is used to deposit a first conductor about the exterior surface of the solid sacrificial material, and the solid sacrificial material is then removed. The first conductor assumes the three-dimensional shape, and is substantially hollow after removing the solid sacrificial material. Contemplated hollow metallic objects include waveguides, heat pipes, and vapor chambers.

This application claims the benefit of priority to U.S. Provisional Patent No. 62/979,190 filed Feb. 20, 2020, which is incorporated by reference in its entirety herein.

### FIELD OF THE INVENTION

The field of the invention relates to methods and systems for manufacturing electrical and electronic components.

### BACKGROUND

The following description includes information that may be useful in understanding the present invention. It is not an admission that any of the information provided herein is prior art or relevant to the presently claimed invention, or that any publication specifically or implicitly referenced is prior art.

As the need to produce high volume, low cost electronic components with high quality and cost effectiveness increases, use of economic and highly machinable sacrificial materials offers a solution. For example, methods of using sacrificial materials to manufacture components can extend to manufacturing electricity transmission lines, capacitors, microfluidic channels, waveguides, and heat pipes, among other components.

With exponential demand for receiving, transmitting, and processing high frequency EM waves, improved methods of manufacturing waveguides are particularly ripe for application of sacrificial materials, providing a distinct competitive edge, for example by increasing efficiency, speed, or simplicity, or reducing material or manufacturing costs. U.S. Pat. No. 6,438,279 to Craighead et al. teaches using a sacrificial layer to form a microchannel for a waveguide, etching irrigation holes to reach the sacrificial layer with a fluid, and using wet chemistry to remove the sacrificial layer from the microchannel to form the waveguide. However, Craighead fails to teach sacrificial materials suitable to form waveguides with highly smooth interior surfaces, or how manufacturing methods for such optical EM waveguides could be adapted to RF waveguides with complex shapes and components, for example those used in telecommunications applications.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

U.S. Pat. No. 7,149,396 to Schmidt et al likewise teaches forming non-solid optical waveguide cores by forming a bottom cladding layer, depositing a sacrificial layer on the cladding layer, covering the sacrificial layer with a top layer, and dissolving the sacrificial layer. However, Schmidt likewise does not teach how such methods for manufacturing delicate optical waveguides could be applied to the manufacture of RF waveguides with the requisite smooth interior surfaces and having complex shapes and components.

U.S. Pat. No. 6,915,054 to Wong teaches methods of forming waveguides for transmitting electrical signals by depositing metal around a sacrificial material and removing the sacrificial material via thermal decomposition, etching, or dissolving. However, Wong does not teach specific sacrificial materials suitable for producing waveguides with smooth interiors, cost effective or efficient methods of depositing the metal layer, or how such methods could be used to manufacture RF waveguides with complex shapes and components.

Thus, there is still a need for improved methods and systems for simple and cost-effective methods to manufacture electrical and electronic components, for example waveguides with complex shapes and components having highly smooth interior surfaces.

### SUMMARY OF THE INVENTION

The inventive subject matter provides systems, methods, and devices related to electromagnetic waveguides and forming electromagnetic waveguides. Methods of forming an electromagnetic waveguide with a three-dimensional shape are contemplated. Preferably, the waveguide is suitable to guide one or more electromagnetic waves with frequencies no more than 300 GHz, though typically less than 200 GHZ, between 100 GHz and 600 MHz, or between 100 GHz and 1 GHz or, for example, a millimeter wave or radio frequency (RF) waveguide.

A solid sacrificial material is formed in the three-dimensional shape, and a precursor is deposited about an exterior surface of the solid sacrificial material. The precursor is used to deposit a first conductor about the exterior surface of the solid sacrificial material, and the solid sacrificial material is then removed. The first conductor typically assumes the three-dimensional shape, and is substantially hollow after removing the solid sacrificial material.

Waveguides are further contemplated with a first conductor having a (substantially) hollow three-dimensional shape. Of critical importance for preferred applications, an interior surface of the first conductor has an Ra of no more than 0.1 μm. This is of critical importance for preferred applications because, as the frequency of the electromagnetic waves to which the waveguide is applied increases, roughness of the interior surface of the waveguide increasingly causes distortion, noise, or signal reduction. However, in some embodiments or applications it may be favorable for the interior surface to have Ra no more than 1 μm, 5 μm, 10 μm, or 50 μm, for example where tolerance of distortion or signal reduction is not an issue or surface roughness is otherwise non-critical to performance (e.g., manufacture of heat pipes, vapor chambers, etc.). The first conductor also has an average thickness less than 10 mm, between 1 mm and 20 nm, though preferably less than 500 μm, less than 200 μm, 10 μm, or 1 μm. The (substantially) hollow three-dimensional shape includes at least one of a cylinder, a serpentine tube, a cone, a sphere, a prism, a pyramid, or a horn, either as part of the overall superstructure of the waveguide or as subcomponents thereof.

It is further contemplated to plate conductors to sacrificial material to form other electrical or electronic components. For example, electrical transmission lines with air cores can be formed by plating to sacrificial materials as discussed above. A precursor is deposited on a portion of the sacrificial material, and a conductor is plated to the precursor. The sacrificial material can be machined or treated as discussed above to include features or elements desired for the transmission line (e.g., trace lines, ground outlets, etc.). In some embodiments, the sacrificial material is at least partially embedded in a substrate (e.g., dielectric, prepreg, etc.) before depositing the plating resist, the precursor, or the conductor. In preferred embodiments, a substrate (e.g., prepreg laminate, epoxy, etc.) is applied to the sacrificial material after the precursor and conductor are deposited to exposed surfaces of the sacrificial material, but before the sacrificial material has been removed. After the conductor is deposited, the sacrificial material is removed (e.g., etched, etc.), yielding a transmission line having conductor and an air core in the space the sacrificial material previously occupied.

Methods to form heat pipes or vapor chambers are further contemplated. A sacrificial material is formed or machined into a pattern for a heat pipe array or a vapor chamber. A precursor is deposited onto at least part (preferably all) of the sacrificial material, and a conductor is deposited to the precursor to form the walls of the heat pipe or vapor chamber. The sacrificial material is then removed (e.g., etched.), forming a hollow pipe vapor chamber. In preferred embodiments, a substrate is applied to the sacrificial material with deposited precursor and conductor before the sacrificial material is removed. Viewed from another perspective, the conductor coated sacrificial material is embedded (at least partially) in a substrate before the sacrificial material is removed. Where the conductor or precursor does not otherwise seal both ends of the hollow pipe, open ends of the hollow pipe are sealed to form the heat pipe. Vapor chambers are likewise sealed at the edges of the chamber. In preferred embodiments, the heat pipe or vapor chamber is partially filled with a fluid or liquid, for example water.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 depicts a flow chart of a method of the inventive subject matter.

FIG. 2 depicts a device of the inventive subject matter.

FIG. 3 depicts steps of another method of the inventive subject matter.

FIGS. 4A to 4C depict variations of devices of the inventive subject matter.

### DETAILED DESCRIPTION

The inventive subject matter provides systems, methods, and devices related to electromagnetic waveguides and forming electromagnetic waveguides. Methods of forming an electromagnetic waveguide with a three-dimensional shape are contemplated. Preferably, the waveguide is suitable to guide one or more electromagnetic waves with frequencies no more than 300 GHz, though typically less than 200 GHZ, between 100 GHz and 600 MHz, between 100 GHz and 1 GHz or, for example, a millimeter wave or radio frequency (RF) waveguide. It should be appreciated that while contemplated waveguides may be applied to the above ranges of frequencies, embodiments of such waveguides are typically applied to a specific frequency (e.g., less than 5%, 1%, or 0.1% variance, etc.), typically in a range of less than 1 octave, 0.5 octave, or less than 0.1 octave from the specific frequency.

A solid or semi-solid (e.g., porous, honeycombed, partially hollowed, etc.) sacrificial material is formed in the three-dimensional shape, and a precursor is deposited about an exterior surface of the solid sacrificial material. The precursor is used to deposit a first conductor about the exterior surface of the solid sacrificial material, and the solid sacrificial material is then removed. In many cases the sacrificial material with the conductor is embedded within a structural material prior to removing the sacrificial material. The structural material holds the first conductor rigidly in place once the sacrificial material is removed.

In some embodiments, the solid or semi solid sacrificial material is aluminum, though other sacrificial materials with smooth surface features that are easy to machine, mold, or stamp and selectively remove from the conductor are also contemplated. For example, the sacrificial material is typically an etchable material, for example etchable (e.g., wet etchant, plasma etchant, etc.) metals (e.g., aluminum, zinc, tin, lead, beryllium, chromium, gold, molybdenum, platinum, tantalum, titanium, tungsten, etc.), polymers, or salts. In some embodiments, the sacrificial material is an amphoteric material, for example amphoteric metals. For example, forming the solid sacrificial material in the three-dimensional shape typically requires machining the solid sacrificial material. The three-dimensional shape is often rectangular in part, but can also include geometries of a cylinder, a serpentine tube, a cone, a sphere, a prism, a pyramid, or a horn, either as part of the overall superstructure of the three dimensional shape or as subcomponents. For example, in some embodiments aluminum (or other described sacrificial material) wire is the sacrificial material, and is used to form tubular waveguides, heat pipes, or microfluidic structures.

The first conductor typically assumes the three-dimensional shape, and is substantially hollow after removing the solid or semi-solid sacrificial material. The solid sacrificial material is removed by solvent removal, thermal removal, plasma removal, or combinations thereof. Suitable materials for the first conductor include cobalt, rhodium, iridium, nickel, palladium, platinum, copper, silver, gold, alloys thereof, or combinations therefrom. The first conductor and the solid sacrificial material are ideally selected such that the removal of the solid sacrificial material does not damage or negatively affect the first conductor with respect to the desired properties of the waveguide, for example smoothness of the first conductors interior surface. Preferably the interior surface of the first conductor has an arithmetic mean roughness (Ra) no more than 0.1 μm, though in some cases the Ra is no more than 1 μm, 0.8 μm, 0.6 μm, 0.4 μm, or 0.2 μm. Viewed from another perspective, the solid sacrificial material is selected and processed such that the exterior surface of the solid sacrificial material has an arithmetic mean roughness (Ra) preferably of no more than 0.1 μm after the step of forming.

It is contemplated to further treat the first conductor with a chemical protectant or pressure before removing the solid or semi-solid sacrificial material, after removing the solid sacrificial material, or a combination thereof. The first conductor (or the combined thickness of the precursor and first conductor) typically has an average thickness of between 1 mm and 20 nm, between 500 μm and 20 nm, or between 100 μm and 20 nm, and is deposited in a pattern. In some embodiments, a second conductor is further deposited in a pattern on the exterior surface of the first conductor, either before or after the solid sacrificial material has been removed. In some embodiments, the sacrificial material with precursor and first conductor (and second conductor where appropriate) are embedded in a structural supporting material, for example laminate or epoxy, before the sacrificial material is removed. This is particularly useful where the thickness of the first conductor (or combined with precursor) is very thin, for example less than 500 μm, 100 μm, or 10 μm. In such embodiments, the structural support material protects the waveguide from deformation or damage, and the walls of the waveguide do not provide significant structural support.

The precursor is used to deposit the first conductor to the sacrificial material, for example a catalyst for electroless plating or preferably a conductor for electrolytic plating (e.g., one or more of Pd, Pt, Au, Ag, Rh, Cu, Ni, or Co, etc.). In some embodiments the precursor is the same as the first conductor. Viewed from another perspective, in such embodiments the precursor includes atoms of the first conductor deposited (e.g., sputtered, chemical vapor deposition, plasma enhanced chemical vapor deposition, electroless plating, electrolytic plating, etc.) onto the sacrificial material, followed by additional plating of atoms of the first conductor to the precursor (e.g., electrolytic plating, etc.). In other embodiments, the catalyst can be either active in the precursor, or in inactive. The precursor can be reduced (e.g., thermally, chemically, etc.) to deposit an electroless plating catalyst about the exterior surface of the solid sacrificial material. In some embodiments, an electroless plating catalyst is deposited about the exterior surface of the solid sacrificial material, and the first conductor is electroless plated about the exterior surface of the solid sacrificial material. Where favorable, electrolytic plating can subsequently be applied to increase the thickness of the first conductor, or add a second conductor, either before or after the solid sacrificial material has been removed.

It is contemplated that the waveguide can be formed to include additional components favorable or useful for performance or application of the waveguide, such as a coaxial input to the waveguide. For example, the sacrificial material can be machined or otherwise shaped to form a waveguide filter element in the sacrificial material. In some embodiments, a portion of the sacrificial material is removed (e.g., etched, machined, ablated, etc.) in the shape or dimension of the waveguide filter element.

The waveguide filter element can include one or more of a cavity resonator, a dielectric resonator filter, an evanescent-mode filter, a corrugated-waveguide filter, a stub filter, or an absorption filter, for example one or more of a tuning screw, an iris, a post, a dual-mode filter, an insert filter, a finline filter, or a waffle-iron filter. Where more than one waveguide filter elements are formed, at least two waveguide filter elements are preferably of the same type. At least one impedance matching component, direction coupler, power combiner, diplexer, duplexer, multiplexer, or directional filter can also be formed in the sacrificial material, alone or in combination with other waveguide elements or features.

It is also contemplated that two separate portions of solid or semi-solid sacrificial materials, each fashioned in its own shape, can be fused or otherwise adhered together to form the overall solid or semi-solid sacrificial material. Such a method is preferable when manufacturing waveguides with complex or diverse geometries, architectures, or components.

Waveguides are further contemplated with a first conductor having a (substantially) hollow three-dimensional shape. Of critical importance, an interior surface of the first conductor has an Ra of no more than 0.1 μm. This is of critical importance because, as the frequency of the electromagnetic waves to which the waveguide is applied increases, roughness of the interior surface of the waveguide increasingly causes distortion, noise, or signal reduction. However, in some embodiments it may be favorable for the interior surface to have Ra no more than 1 μm, 5 μm, 10 μm, or 50 μm, for example where tolerance of distortion or signal reduction is not an issue or surface roughness is otherwise non-critical to performance (e.g., manufacture of heat pipes, vapor chambers, etc.). The first conductor also has an average thickness less than 10 mm, between 1 mm and 20 nm, though preferably less than 500 μm. The (substantially) hollow three-dimensional shape includes at least one of a cylinder, a serpentine tube, a cone, a sphere, a prism, a pyramid, or a horn, either as part of the overall superstructure of the waveguide or as subcomponents thereof.

Waveguides can also include elements or components useful for the application or use of the waveguide. For example, a second conductor can be deposited in a pattern on an exterior surface of the first conductor, to form wires, traces, or lines, for example to transmit electrical signals to the waveguide. The shape of the waveguide can also include a coaxial input to the waveguide, a filter element, an impedance matching component, a direction coupler, a power combiner, a diplexer, a duplexer, a multiplexer, a directional filter, or combinations thereof. The waveguide is generally designed for guiding an electromagnetic wave with frequency no more than 300 GHz, and is preferably a millimeter wave or RF waveguide. In some embodiments, exterior surfaces or interior surfaces of the wave guide are coated by a chemical protectant layer, for example to resist corrosive environmental elements, etc.

Uses of waveguides to guide an electromagnetic wave with frequency no more than 300 GHz are further contemplated, whether integrated in avionics, satellites, broadband telecommunication, remote sensors, or internet of things connected devices.

It is further contemplated to plate conductors to solid or semi-solid sacrificial material to form other electrical or electronic components. For example, electrical transmission lines with air cores can be formed by plating to sacrificial materials as discussed above. A precursor is deposited on a portion of the sacrificial material, and a conductor is plated to the precursor. The sacrificial material can be machined or treated as discussed above to include features or elements desired for the transmission line (e.g., trace lines, ground outlets, etc.).

In some embodiments, a plating resist is deposited on the sacrificial material forming a negative pattern of a desired conductor pattern, with the precursor and subsequent conductor deposited to the exposed portions of the sacrificial material. In some embodiments, the sacrificial material is at least partially embedded in a substrate (e.g., dielectric, prepreg, etc.) before depositing the plating resist, the precursor, or the conductor. In preferred embodiments, a substrate (e.g., prepreg laminate, epoxy, etc.) is applied to the sacrificial material after the precursor and conductor are deposited to exposed surfaces of the sacrificial material, but before the sacrificial material has been removed. After the conductor is deposited, the sacrificial material is removed (e.g., etched, etc.), yielding a transmission line having conductor and an air core in the space the sacrificial material previously occupied.

Methods to form heat pipes or vapor chambers are further contemplated. A solid or semi-solid sacrificial material is formed or machined into a pattern for a heat pipe array or a vapor chamber. A precursor is deposited onto at least part (preferably all) of the sacrificial material, and a conductor is deposited to the precursor to form the walls of the heat pipe or vapor chamber. The sacrificial material is then removed (e.g., etched.), forming a hollow pipe vapor chamber. In preferred embodiments, a substrate is applied to the sacrificial material with deposited precursor and conductor before the sacrificial material is removed. Viewed from another perspective, the conductor coated sacrificial material is embedded (at least partially) in a substrate before the sacrificial material is removed. Where the conductor or precursor does not otherwise seal both ends of the hollow pipe, open ends of the hollow pipe are sealed to form the heat pipe. Vapor chambers are likewise sealed at the edges of the chamber. In preferred embodiments, the heat pipe or vapor chamber is partially filled with a fluid or liquid, for example water.

Arrays can include one or more heat pipes, vapor chambers, or combinations thereof, with each heat pipe or vapor chamber having a geometric conformation. For example, the heat pipe or vapor chamber typically has a circular or ovoid cross section, but can also have an angular cross section (e.g., triangular, rectangular, square, pentagonal, hexagonal, etc.), or further include grooves along the interior surface to move fluid or liquid in the heat pipe or vapor chamber through capillary action. Heat pipes can extend substantially straight between two capped or sealed ends of the pipe, or can include one or more curves or angles (e.g., obtuse, acute, or right), while vapor chambers are substantially planar (optionally with one or more curves or angles) and can include pillars with groves to cause capillary action of the fluid. For example, a heat pipe can at least partially include a spiral, concentric, and repeating geometric shapes, a series of serpentine lines, or combinations thereof. In preferred embodiments, the sacrificial material is aluminum wire with diameter no more than 10 mm, 1 mm, 100 μm, or 10 μm, or an aluminum plate or hollow box defining the interior of a vapor chamber.

Moreover, where a heat pipe array includes more than one heat pipe, each heat pipe can have the same, substantially the same, or completely different geometric conformations, and can be applied to a system substantially adjacent to one another, partially overlapping, or substantially overlapping each other. For example, where a first heat pipe has n serpentine bends parallel to each other, and a second heat pipe has substantially the same conformation, the first and second heat pipes are overlaid such that the straight portions of the first heat pipe are substantially perpendicular with the straight portions of the second heat pipe. In preferred embodiments, arrays including more than one substantially similar heat pipes are overlaid with each other in a geometrically balanced fashion (e.g., two heat pipes are overlaid substantially 90° askew with each other, three heat pipes are overlaid substantially 60° askew with each other, etc.). Likewise, more than one vapor chamber can used or combined with heat pipes.

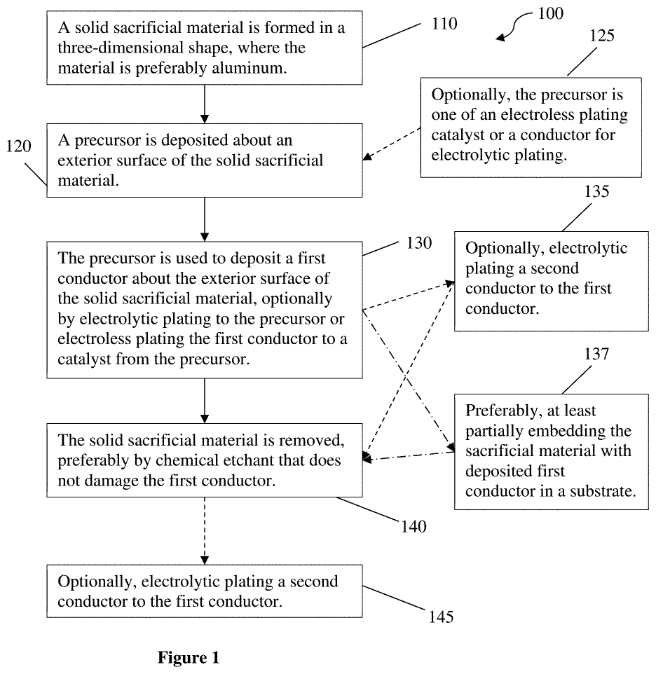

FIG. 1 depicts flow chart 100 of the inventive subject matter for forming an electromagnetic waveguide with a three-dimensional shape is contemplated, including steps 110, 120, 130, and 140 performed in sequence, with optional steps 125, 135, and 145 and preferable step 137 performed as indicated, as alternatives or in combination.

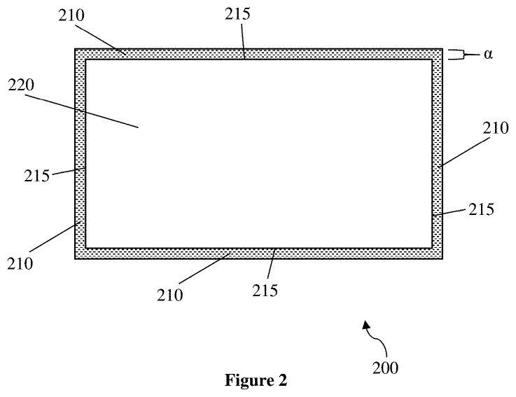

FIG. 2 depicts wave guide 200 of the inventive subject matter. Waveguide 200 has a generally rectangular shape, with walls 210, interior surfaces 215, and hollow core 220. Walls 210 are typically copper, but other conductive metals are contemplated. Walls 210 have a thickness a between 1 mm and 20 nm thick, preferably less than 200 μm thick. Interior surface 215 has an Ra of no more than 0.1 μm, preferably no more than 0.01 μm. Optionally, the exterior surface of walls 210, or interior surface walls 215, or both, can be coated by a protective layer, for example to protect from corrosion. Though not depicted, it is contemplated waveguide 200 optionally includes further waveguide elements, such as filters, impedance matching components, direction couplers, power combiners, diplexers, duplexers, multiplexers, or directional filters. In preferred embodiments, waveguide 200 is formed by the method of FIG. 100.

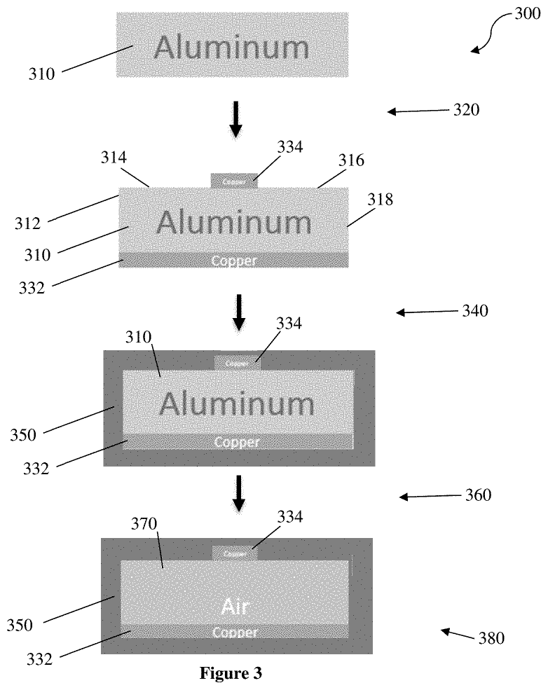

FIG. 3 depicts method 300 for manufacturing air-core transmission line 380. Sacrificial material 310 (here aluminum) is machined into a form, followed by step 320 where conductors 332 and 334 (here copper) are deposited onto the sacrificial material. Any suitable means of depositing conductors 332 and 334 are contemplated, including optionally depositing a plating resist layer onto surfaces 312, 314, 316, and 318 of sacrificial material 310, followed by plating conducts 332 and 334 onto surfaces of sacrificial material 310 not covered by the plating resist layer. In step 340, substrate 350 (e.g., dielectric, prepreg laminate, etc.) is placed about sacrificial material 310. Viewed from another perspective, sacrificial material 310 is embedded in substrate 350. In step 360, sacrificial material 310 is removed (e.g., etched), yielding air-core transmission line 380, having substrate 350, conductors 332 and 334, and air-core 370.

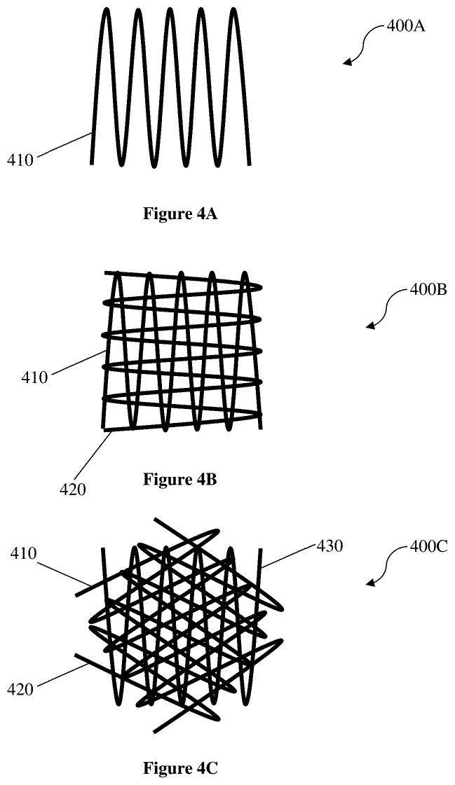

FIG. 4A depicts heat pipe array 400A made by the disclosed methods. Heat pipe array 400A includes heat pipe 410 arranged in a serpentine pattern and partially filled with a fluid. FIG. 4B depicts heat pipe array 400B made by the disclosed methods. Heat pipe array 400B includes heat pipes 410 and 420 arranged in a serpentine pattern and partially filled with a fluid. Heat pipes 410 and 420 are substantially similar, substantially overlap each other, and are arranged approximately 90° askew from each other. FIG. 4C depicts heat pipe array 400C made by the disclosed methods. Heat pipe array 400C includes heat pipes 410, 420, and 430 arranged in a serpentine pattern and partially filled with a fluid. Heat pipes 410, 420, and 430 are substantially similar, substantially overlap each other, and are arranged approximately 60° askew from each other.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of forming an electromagnetic waveguide having a three-dimensional shape to guide an electromagnetic wave with frequency no more than 200 GHz, comprising:
forming a solid sacrificial material in the three-dimensional shape;
depositing a precursor about an exterior surface of the solid sacrificial material;
using the precursor to deposit a first conductor about the exterior surface of the solid sacrificial material; and
removing the solid sacrificial material.

2. The method of claim 1, wherein the solid sacrificial material is an etchable material.

3. The method of claim 1, further comprising the step of at least partially embedding the solid sacrificial material with deposited first conductor in a substrate before removing the solid sacrificial material.

4. The method of claim 1, wherein the first conductor has the three-dimensional shape.

5. The method of claim 1, wherein the first conductor is substantially hollow after removing the solid sacrificial material.

6. The method of claim 1, wherein the first conductor is one of cobalt, rhodium, iridium, nickel, palladium, platinum, copper, silver, or gold.

7. The method of claim 1, wherein the step of forming the solid sacrificial material in the three-dimensional shape comprises machining the solid sacrificial material.

8. The method of claim 1, wherein the solid sacrificial material is removed by at least one of solvent removal, thermal removal, or plasma removal.

9. The method of claim 1, wherein the three-dimensional shape further comprises a coaxial input to the waveguide.

10. The method of claim 1, wherein an interior surface of the first conductor has an arithmetic mean roughness (Ra) no more than 1 μm.

11. The method of claim 1, wherein the exterior surface of the solid sacrificial material has an arithmetic mean roughness (Ra) of no more than 1 μm after the step of forming.

12. The method of claim 1, further comprising the step of treating the first conductor with a chemical protectant or pressure either before or after removing the solid sacrificial material.

13. The method of claim 1, wherein the first conductor has an average thickness between 500 μm and 20 nm.

14. The method of claim 1, further comprising a step of depositing a second conductor in a pattern on the exterior surface of the first conductor.

15. The method of claim 1, wherein the waveguide is a radio frequency (RF) waveguide.

16. The method of claim 1, wherein the precursor comprises either a catalyst for electroless plating or a material for electrolytic plating.

17. The method of claim 16, wherein the catalyst or material is one of Pd, Pt, Au, Ag, Rh, Cu, Ni, or Co, and is either active or inactive.

18. The method of claim 1, wherein the precursor is the same as the first conductor.

19. The method of claim 1, further comprising the step of reducing the precursor to deposit an electroless plating catalyst about the exterior surface of the solid sacrificial material.

20. The method of claim 1, wherein the step of using the precursor to deposit a first conductor comprises:
depositing an electroless plating catalyst about the exterior surface of the solid sacrificial material; and
electroless plating the first conductor about the exterior surface of the solid sacrificial material.

21. The method of claim 1, wherein the step of forming the solid sacrificial material comprises forming a waveguide filter element in the solid sacrificial material.

22. The method of claim 21, wherein the step of forming the waveguide filter element comprises removing a portion of the solid sacrificial material in the shape and dimension of the waveguide filter element.

23. The method of claim 21, wherein the waveguide filter element is selected from the group consisting of a tuning screw, an iris, a post, a dual-mode filter, an insert filter, a finline filter, or a waffle-iron filter.

24. The method of claim 21, wherein the waveguide filter element is selected from the group consisting of a cavity resonator, a dielectric resonator filter, an evanescent-mode filter, a corrugated-waveguide filter, a stub filter, or an absorption filter.

25. The method of claim 1, wherein the step of forming the solid sacrificial material comprises forming at least one of an impedance matching component, a direction coupler, a power combiner, a diplexer, a duplexer, a multiplexer, or a directional filter in the solid sacrificial material.

26. The method of claim 1, wherein the three-dimensional shape includes at least in part one of a cylinder, a serpentine tube, a cone, a sphere, a prism, a pyramid, or a horn.

27. A waveguide comprising a first conductor having a hollow three-dimensional shape, wherein an interior surface of the first conductor has an arithmetic mean roughness (Ra) of no more than 1 μm, wherein the first conductor has an average thickness between 500 μm and 20 nm, and the hollow three-dimensional shape includes at least one of a cylinder, a serpentine tube, a cone, a sphere, a prism, a pyramid, or a horn.

28. The waveguide of claim 27, further comprising a second conductor deposited in a pattern on an exterior surface of the first conductor.

29. The waveguide of claim 27, wherein the hollow three-dimensional shape further comprises a coaxial input to the waveguide.

30. The waveguide of claim 27, wherein the waveguide is for guiding an electromagnetic wave with frequency no more than 200 GHz.

31. The waveguide of claim 27, further comprising a chemical protectant layer deposited on an interior surface of the first conductor.

32. The waveguide of claim 27, further comprising the first conductor at least partially embedded in a substrate.

33. The waveguide of claim 1, wherein the solid sacrificial material is one of an etchable metal, polymer, or salt, wherein the etchable metal is one of an amphoteric metal, aluminum, zinc, tin, or lead.

34. A method of forming a component having a three-dimensional shape, comprising:
forming a sacrificial material in the three-dimensional shape;
depositing a precursor about an exterior surface of the sacrificial material;
using the precursor to deposit a conductor about the exterior surface of the sacrificial material, forming an interim component;
at least partially embedding the interim component in a substrate; and
removing the sacrificial material.

35. The method of claim 34, wherein the component is an air-core electric transmission line.

36. The method of claim 34, further comprising the step of depositing a resist layer about the exterior surface of the sacrificial material in a negative pattern for a conductor pattern before depositing the precursor.

37. The method of claim 34, further comprising the step of partially filling the component with a fluid.

38. The method of claim 34, wherein the component has a first open end and a second open end, further comprising the step of sealing the first and second open ends with the conductor.

39. The method of claim 34, wherein the component is either a heat pipe or a vapor chamber.
